(19) United States
(12) Patent Application Publication
(10) Pub. No.: US 2024/0005351 A1
(43) Pub. Date: Jan. 4, 2024

(54) VERIFICATION METHOD AND INFORMATION PROCESSING APPARATUS

(71) Applicant: FUJITSU LIMITED, Kawasaki-Shi (JP)

(72) Inventors: Takuya SAKAMOTO, Kawasaki (JP); Mebae YAMAOKA, Kawasaki (JP); Takeru FUKUOKA, Chuo (JP)

(73) Assignee: FUJITSU LIMITED, Kawasaki-Shi (JP)

(21) Appl. No.: 18/467,791

(22) Filed: Sep. 15, 2023

Related U.S. Application Data
(63) Continuation of application No. PCT/JP21/13836, filed on Mar. 31, 2021.

(51) Int. Cl. G06Q 30/0207

(52) U.S. Cl. CPC G06Q 30/0225

(57) ABSTRACT

An information processing apparatus receives identification information for identifying a given deal and item information specified by a user amongst multiple pieces of item information included in execution results of the given deal. With reference to a storing unit that stores, for each of multiple deals, identification information for identifying the deal in association with multiple pieces of confidential information which are individually generated by concealing each of multiple pieces of item information included in execution results of the deal, the information processing apparatus acquires, amongst pieces of confidential information associated with the identification information, at least the confidential information corresponding to the item information. The information processing apparatus verifies the authenticity of the item information based on a correspondence between the item information and the confidential information.

### CROSS-REFERENCE TO RELATED APPLICATION

This application is a continuation application of International Application PCT/JP2021/013836 filed on Mar. 31, 2021, which designated the U.S., the entire contents of which are incorporated herein by reference.

### FIELD

The embodiments discussed herein relate to a verification method and information processing apparatus.

### BACKGROUND

Information processing systems may facilitate proof of authenticity of deal information by recording the deal information in a database accessible by multiple users. The database for recording the deal information may be a blockchain, which is a distributed database offering high tamper resistance. A blockchain is sometimes called a distributed ledger, and deal information is sometimes called a transaction. A blockchain has a list structure where multiple blocks are linked to each other.

There is a proposed blockchain system for determining an information type based on the confidentiality level of deal information, selecting one of blockchains according to the determined information type, and writing the deal information on the selected blockchain.

See, for example, International Publication Pamphlet No. WO 2018/214898.

### SUMMARY

According to one embodiment, there is provided a verification method including: receiving, by a processor, a first identification information piece for identifying a first deal performed by a user and a first item information piece specified by the user amongst a plurality of first item information pieces included in execution results of the first deal; acquiring, by the processor, in reference to a memory for storing, for each of a plurality of deals, an identification information piece for identifying the deal in association with a plurality of confidential information pieces which is individually generated by concealing each of a plurality of item information pieces included in execution results of the deal, at least a first confidential information piece corresponding to the specified first item information piece amongst a plurality of first confidential information pieces associated with the first identification information piece; and verifying, by the processor, authenticity of the specified first item information piece based on a correspondence between the specified first item information piece and the acquired first confidential information piece.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing system according to a first embodiment;

FIG. 2 illustrates an example of an information processing system according to a second embodiment;

FIG. 3 is a block diagram illustrating a hardware example of a terminal device;

FIG. 4 illustrates a first example of deal proof using blockchains;

FIG. 5 illustrates a second example of the deal proof using the blockchains;

FIG. 6 is a block diagram illustrating an example of functions of the information processing system;

FIG. 7 is a flowchart illustrating an example of a deal execution procedure;

FIG. 8 is a flowchart illustrating an example of a deal proof procedure;

FIG. 9 illustrates a third example of the deal proof using the blockchains; and

FIG. 10 illustrates a fourth example of the deal proof using the blockchains.

### DESCRIPTION OF EMBODIMENTS

A deal executor may desire to disclose to a verifier item information of a particular item included in deal information and claim that the disclosed item information is true. For example, when an employee of a company has purchased goods or services in the course of business, he or she may want to make an expense claim to the company. If the deal information itself is recorded in a database, the verifier is able to confirm that the item information disclosed by the deal executor matches the record in the database.

However, if the deal information itself is recorded in a database accessible by the verifier and the verifier is able to refer to the entire deal information, there is a risk that confidential information of the deal executor could be leaked to the verifier. For example, if the deal information includes a user ID given to the deal executor by a deal system, the verifier may be able to acquire the user ID of the deal executor and learn of other deals made by the deal executor in the past.

Several embodiments will be described below with reference to the accompanying drawings.

### First Embodiment

A first embodiment is described hereinafter.

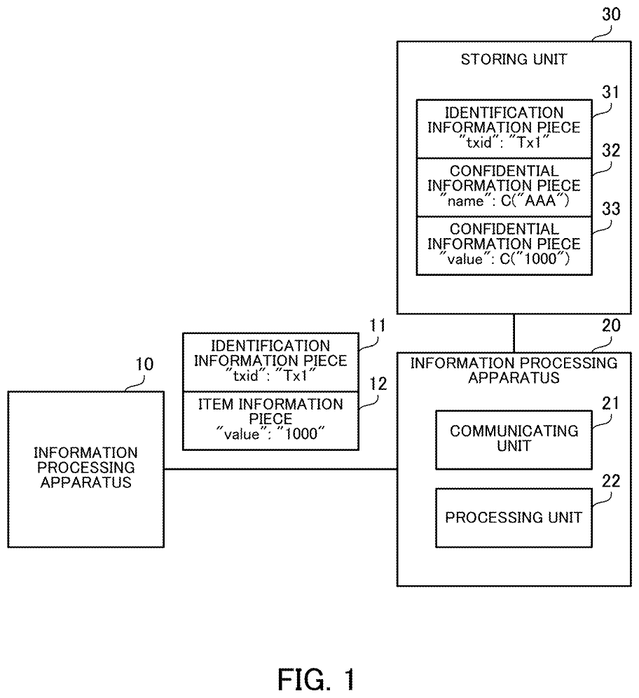

FIG. 1 illustrates an information processing system according to the first embodiment.

The information processing system of the first embodiment verifies the authenticity of deal-related information disclosed by a deal executor to a verifier. The information processing system includes information processing apparatuses 10 and 20 and a storing unit 30. The information processing apparatuses 10 and 20 and the storing unit 30 are connected to, for example, a network. The network may include a local area network (LAN) or the Internet. Note that the storing unit 30 may be included in the information processing apparatus 20.

The information processing apparatus 10 presents information on an executed deal to the information processing apparatus 20. The information processing apparatus 10 is a terminal device, such as a smartphone, a tablet terminal, a personal computer (PC), or the like used by the deal executor. The information processing apparatus verifies the information presented by the information processing apparatus 10. The information processing apparatus 20 is a terminal device, such as a smartphone, a tablet terminal, a PC, or the like used by the verifier.

For example, the information processing apparatus transmits a deal request to a dealing system to purchase a product or service for use in business, and receives deal information indicating the executed deal from the dealing system. The dealing system may be a blockchain system using a blockchain. The deal information indicates the execution results of the deal, and includes multiple pieces of item information corresponding to multiple items. The information processing apparatus 10 transmits to the information processing apparatus 20 item information pieces indicating the name of the purchased item and the purchase price, and requests settlement of the purchase price paid in advance. The information processing apparatus 20 receives the item information pieces from the information processing apparatus 10 and verifies the fact that the deal has been made as indicated in the item information pieces.

The information processing apparatus 20 includes a communicating unit 21 and a processing unit 22. The communicating unit 21 is a communication interface connected to the network. The communicating unit 21 may be either a wired or wireless communication interface. The processing unit 22 executes information processing. The processing unit 22 may be a processor, such as a central processing unit (CPU), graphics processing unit (GPU), or digital signal processor (DSP). The processing unit 22 may execute programs stored in memory, such as a random access memory (RAM). In addition, the processing unit 22 may include an electronic circuit, such as an application specific integrated circuit (ASIC) or field programmable gate array (FPGA).

The communicating unit 21 receives an identification information piece 11 and an item information piece 12 from the information processing apparatus 10. The identification information piece 11 is information for identifying a deal made by the user, and is sometimes called a transaction ID. The item information piece 12 is, amongst a plurality of pieces of item information included in execution results of the deal, an item information piece specified by the user. Two or more pieces of item information may be specified. For example, the item information piece 12 is item information indicating the name of a purchased product or service, or item information indicating the purchase price.

Note here that the information processing apparatus 10 does not have to transmit all the pieces of item information included in the deal execution results to the information processing apparatus 20, and is allowed to hide some pieces of item information not used for verification. For example, when the deal execution results include the user ID of the deal executor, the information processing apparatus 10 need not transmit the user ID to the information processing apparatus 20.

The processing unit 22 verifies the authenticity of the specified item information piece 12. At this time, the processing unit 22 refers to the storing unit 30. The storing unit 30 stores, for each of multiple deals, an identification information piece for identifying the deal in association with multiple pieces of confidential information. The identification information piece and the multiple pieces of confidential information are recorded, for example, by the dealing system at the time the deal is executed. In addition, the identification information piece and the multiple pieces of confidential information are recorded, for example, on a blockchain, which is a distributed database offering high tamper resistance. A blockchain is sometimes called a distributed ledger.

The multiple pieces of confidential information correspond to multiple pieces of item information included in the deal execution results. One piece of confidential information is generated by concealing one piece of item information. Each piece of confidential information is generated in such a manner that it is difficult to guess an original piece of item information from the piece of confidential information alone. For example, each confidential information piece is a hash value calculated from a piece of item information using a hash function. Alternatively, each confidential information piece is, for example, a ciphertext obtained by encrypting a piece of item information. To generate such a confidential information piece, a random number may be used in addition to a piece of item information. For example, the dealing system selects a random number for each item, and notifies the information processing apparatus 10 of the selected random number together with an item information piece. Items for which confidential information pieces are stored in the storing unit 30 may be only some of the multiple items making up the deal execution results.

The storing unit 30 stores therein an identification information piece 31 and confidential information pieces 32 and 33 for a given deal. The confidential information piece 32 is generated by concealing a piece of item information included in the deal execution results. For example, the confidential information piece 32 corresponds to a piece of item information indicating the name of the purchased product or service. The confidential information piece 33 is generated by concealing a piece of item information different from that of the confidential information piece 32. For example, the confidential information piece 33 corresponds to a piece of item information indicating the purchase price.

The processing unit 22 refers to the storing unit 30 and acquires, amongst multiple pieces of confidential information corresponding to the identification information piece 11, at least a piece of confidential information corresponding to the item information piece 12. At this time, the processing unit 22 may acquire all of the multiple pieces of confidential information corresponding to the identification information piece 11. For example, when the identification information piece 11 and the identification information piece 31 are the same, the processing unit 22 acquires the confidential information pieces 32 and 33 associated with the identification information piece 31 from the storing unit 30. When the item information piece 12 is item information indicating the purchase price, the processing unit 22 may acquire only the confidential information piece 33 from the storing unit 30.

The processing unit 22 verifies the authenticity of the item information piece 12 based on a correspondence between the specified item information piece 12 and the confidential information piece 33 related to the same item as that of the item information piece 12. For example, the processing unit 22 conceals the item information piece 12, and determines whether the confidential information piece generated from the item information piece 12 matches the confidential information piece 33. The processing unit 22 may calculate a hash value of the item information piece 12 and determine whether the hash value of the item information piece 12 matches the confidential information piece 33. If they match, the verification is successful and the presented item information piece 12 is determined to be authentic. If they do not match, the verification fails and the presented item information piece 12 is determined to be false.

When a random number is used to generate the confidential information piece 33, the information processing apparatus 10 may also transmit the random number to the information processing apparatus 20. The processing unit 22 may conceal the item information piece 12 using the received random number, which is then compared with the confidential information piece 33.

Instead of transmitting the random number, the information processing apparatus 10 may transmit, to the information processing apparatus 20, zero-knowledge proof information indicating that the information processing apparatus 10 knows the random number used to convert the item information piece 12 into the confidential information piece 33. This zero-knowledge proof information is a set of numerical values, and is information difficult to generate to be consistent with the item information piece 12 and the confidential information piece 33 without knowing the correct random number. The processing unit 22 verifies if the zero-knowledge proof information is correct by, for example, inputting the item information piece 12, the confidential information piece 33, and the zero-knowledge proof information into a verification algorithm and thereby approves the authenticity of the item information piece 12.

The processing unit 22 outputs the verification results of the item information piece 12. For example, the processing unit 22 displays the verification results on a display device; stores them in a non-volatile storage device; and/or transmits them to a different information processing apparatus.

As described above, the information processing apparatus 20 of the first embodiment receives the identification information piece 11 for identifying a deal and the item information piece 12 specified by the user amongst multiple pieces of item information included in the execution results of the deal. The information processing apparatus 20 refers to the storing unit 30 and acquires the confidential information piece 33 corresponding to the identification information piece 11. The information processing apparatus 20 verifies the authenticity of the item information piece 12 based on the correspondence between the item information piece 12 and the confidential information piece 33.

Herewith, the information processing apparatus 20 is able to check if the item information piece 12 presented by the information processing apparatus 10 is genuine item information included in the deal execution results and has not been tampered with. For example, the information processing apparatus 20 is able to check if the name of a deal object and the deal price reported from the information processing apparatus 10 are genuine and have not been tampered with.

In addition, the information processing apparatus 10 does not have to transmit all pieces of item information included in the deal execution results to the information processing apparatus 20 and only has to transmit some pieces of item information to be verified by the information processing apparatus 20. On the other hand, the storing unit 30 stores, for each item, a confidential information piece instead of an item information piece. Therefore, for the deal identified by the identification information piece 11, the information processing apparatus 20 does not acquire an item information piece itself from the storing unit 30. This reduces the risk of confidential information, such as personal information of the deal executor, being leaked to the verifier.

For example, the deal execution results may include a user ID assigned to the deal executor by the dealing system. If the information processing apparatus 10 also transmits the user ID to the information processing apparatus 20 during verification of the item information piece 12, the verifier would know the user ID of the deal executor. In addition, if the user ID itself associated with the identification information piece 11 is stored in the storing unit 30, the verifier would know the user ID of the deal executor by referring to the storing unit 30. In that case, the verifier may be able to refer to records of other deals that the deal executor made in the past. On the other hand, according to the first embodiment, it is possible to prevent leakage of the user ID of the deal executor.

### Second Embodiment

Next, a second embodiment is described.

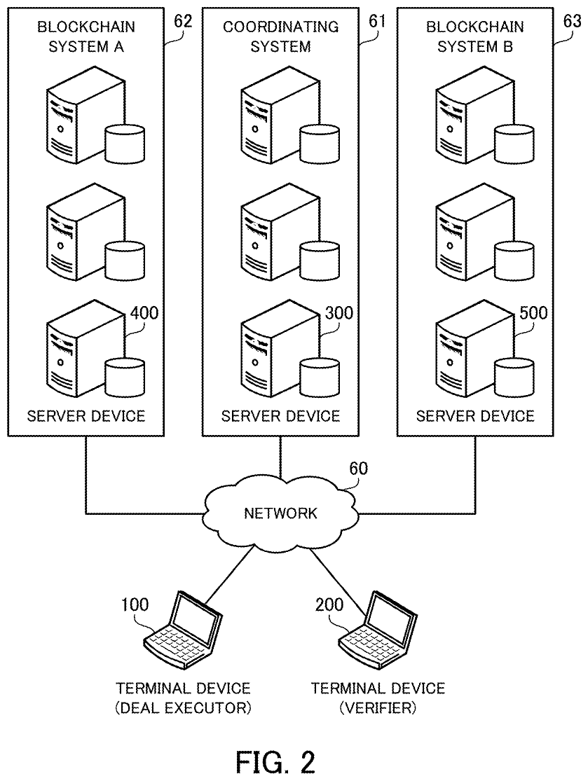

FIG. 2 illustrates an example of an information processing system according to the second embodiment.

The information processing system of the second embodiment includes a coordinating system 61, blockchain systems 62 and 63, and terminal devices 100 and 200, all connected to a network 60. The network 60 may include a LAN and/or the Internet. The coordinating system 61 has multiple server devices, including a server device 300. The blockchain system 62 has multiple server devices, including a server device 400. The blockchain system 63 has multiple server devices, including a server device 500.

The terminal device 100 corresponds to the information processing apparatus 10 of the first embodiment. The terminal device 200 corresponds to the information processing apparatus 20 of the first embodiment. The server device 300, or a memory device included in the server device 300, corresponds to the storing unit 30 of the first embodiment.

The coordinating system 61 and the blockchain systems 62 and 63 individually execute deals and record execution results of the deals on blockchains. In response to a deal request from a user, the coordinating system 61 realizes a series of deals by coordinating multiple blockchain systems. The blockchain systems 62 and 63 each perform a specific type of deal in response to a request from the coordinating system 61. The coordinating system 61 may be called a connection chain, and the blockchain systems 62 and 63 may be called end chains.

For example, the blockchain system 62 is a payment system for transferring money between users. The blockchain system 63 is a service dealing system for transferring tokens, which represent service usage rights, between users. The coordinating system 61 requests the blockchain system 63 to transfer a token from a first user to a second user, and requests the blockchain system 62 to transfer money from the second user to the first user. Herewith, the coordinating system 61 implements a sales contract for a service usage right.

The blockchain systems 62 and 63 are dealing systems independent of each other, and individually issue unique user IDs to users. In addition, the coordinating system 61 and the blockchain systems 62 and 63 individually assign unique transaction IDs to deals. Note that, in the second embodiment, multiple cooperative dealing systems are blockchain systems; however, they may be other types of information processing systems (off-chain systems).

Blockchains are distributed databases offering high tamper resistance. Each blockchain includes multiple blocks linked to each other. Each block contains one or more transactions, which are deal data. Each transaction includes a transaction ID for identifying a deal, and also includes one or more (usually two or more) pairs of an item name and an item value. In addition, each block includes a hash value of the previous block. A newly created transaction is added to the last block of the blockchain.

The server devices 300, 400, and 500 are server computers for executing deals and also managing blockchains. In response to a deal request from the terminal device 100, the server device 300 calls the server devices 400 and 500. The server device 300 generates a transaction representing that information processing of the server devices 400 and 500 forms a series of deals, and records the transaction on the blockchain of the coordinating system 61. The multiple server devices included in the coordinating system 61 each have a duplicate of the same blockchain.

In response to a deal request from the server device 300, the server device 400 performs particular information processing that forms part of the series of deals. The server device 400 generates a transaction representing execution results of a deal that the blockchain system 62 is in charge of, and then records the transaction on its own blockchain. The multiple server devices included in the blockchain system 62 each have a duplicate of the same blockchain. Similarly, in response to a deal request from the server device 300, the server device 500 performs particular information processing that forms part of the series of deals. The server device 500 generates a transaction representing execution results of a deal that the blockchain system 63 is in charge of, and then records the transaction on its own blockchain. The multiple server devices included in the blockchain system 63 each have a duplicate of the same blockchain.

In addition, the server device 300 reads a transaction from the blockchain owned by the coordinating system 61 and transmits it in response to a reference request from the outside of the coordinating system 61. The reference request specifies, for example, a transaction ID. Similarly, the server device 400 reads a transaction from the blockchain owned by the blockchain system 62 and transmits it in response to a reference request from the outside of the blockchain system 62. The server device 500 reads a transaction from the blockchain owned by the blockchain system 63 and transmits it in response to a reference request from the outside of the blockchain system 63.

The terminal device 100 is a client computer used by a deal executor. The terminal device 100 is, for example, a smartphone, tablet terminal, notebook PC, or desktop PC. The terminal device 100 transmits a deal request to the coordinating system 61. The deal request includes the type of a deal and input data for executing the deal. The input data includes, for example, the user IDs of dealing parties, the identifier of a deal object, and an amount of money to be dealt. The terminal device 100 receives deal data which represents execution results of the deal from the coordinating system 61.

In addition, in accordance with an instruction from the deal executor, the terminal device 100 transmits to the terminal device 200 proof information for claiming the correctness of specific item values included in the deal data. For example, when the deal executor has purchased the right to use a service for business and has temporarily paid the cost on behalf of his or her company, he or she subsequently charges the company for the purchase expenses. At that time, the terminal device 100 transmits proof information including the service name and the purchase price to the terminal device 200.

The terminal device 200 is a client computer used by a verifier. The verifier is, for example, an accountant of the company. The terminal device 200 is, for example, a smartphone, tablet terminal, notebook PC, or desktop PC. The terminal device 200 receives the proof information from the terminal device 100. The terminal device 200 accesses the coordinating system 61 based on the proof information, and acquires a transaction recorded in the coordinating system 61. The terminal device 200 may also access the blockchain systems 62 and 63.

The terminal device 200 verifies the authenticity of the item values included in the proof information by comparing the received proof information and the recorded transaction. For example, the terminal device 200 checks if the service name and purchase amount received from the terminal device 100 are consistent with the transaction recorded on the blockchain. If the verification is successful, the verifier determines that the item values received from the terminal device 100 have not been tampered with and that the claim from the deal executor is valid. If the verification fails, the verifier determines that the item values received from the terminal device 100 may have been tampered with and that the claim from the deal executor is invalid.

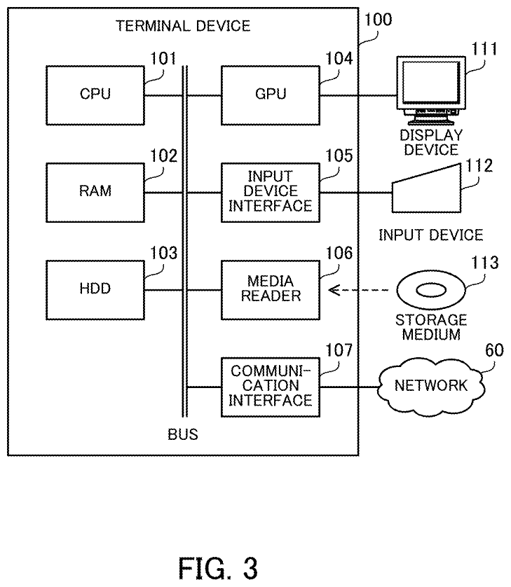

FIG. 3 is a block diagram illustrating a hardware example of a terminal device.

The terminal device 100 includes a CPU 101, a RAM 102, an HDD 103, a GPU 104, an input device interface 105, a media reader 106, and a communication interface 107, which are all connected to a bus. The terminal device 200 and the server devices 300, 400, and 500 may have the same hardware configuration as the terminal device 100.

The CPU 101 is a processor configured to execute program instructions. The CPU 101 reads out at least part of programs and data stored in the HDD 103, loads them into the RAM 102, and executes the loaded programs. Note that the terminal device 100 may include two or more processors. The term “multiprocessor”, or simply “processor”, may be used to refer to a set of processors.

The RAM 102 is volatile semiconductor memory for temporarily storing therein programs to be executed by the CPU 101 and data to be used by the CPU 101 for its computation. The terminal device 100 may be provided with a different type of volatile memory other than RAM.

The HDD 103 is a non-volatile storage device to store therein software programs, such as an operating system (OS), middleware, and application software, and various types of data. The terminal device 100 may be provided with a different type of non-volatile storage device, such as flash memory or a solid state drive (SSD).

The GPU 104 performs image processing in cooperation with the CPU 101, and displays video images on a screen of a display device 111 coupled to the terminal device 100. The display device 111 may be a cathode ray tube (CRT) display, a liquid crystal display (LCD), an organic electro-luminescence (OEL) display, or a projector. An output device, such as a printer, other than the display device 111 may be connected to the terminal device 100.

The input device interface 105 receives an input signal from an input device 112 connected to the terminal device 100. Various types of input devices may be used as the input device 112, for example, a mouse, a touch panel, or a keyboard. Multiple types of input devices may be connected to the terminal device 100.

The media reader 106 is a device for reading programs and data recorded on a storage medium 113. The storage medium 113 may be, for example, a magnetic disk, an optical disk, or semiconductor memory. Examples of the magnetic disk include a flexible disk (FD) and HDD. Examples of the optical disk include a compact disc (CD) and digital versatile disc (DVD). The media reader 106 copies the programs and data read out from the storage medium 113 to a different storage medium, for example, the RAM 102 or the HDD 103. The read programs may be executed by the CPU 101.

The storage medium 113 may be a portable storage medium and used to distribute the programs and data. In addition, the storage medium 113 and the HDD 103 may be referred to as computer-readable storage media.

The communication interface 107 is connected to the network 60 and communicates with the terminal device 200 and the server device 300 via the network 60. The communication interface 107 may be a wired communication interface connected to a wired communication device, such as a switch or router, or may be a wireless communication interface connected to a wireless communication device, such as a base station or access point.

Next described are formats of transactions recorded in the coordinating system 61 and a format of proof information transmitted from the terminal device 100 to the terminal device 200.

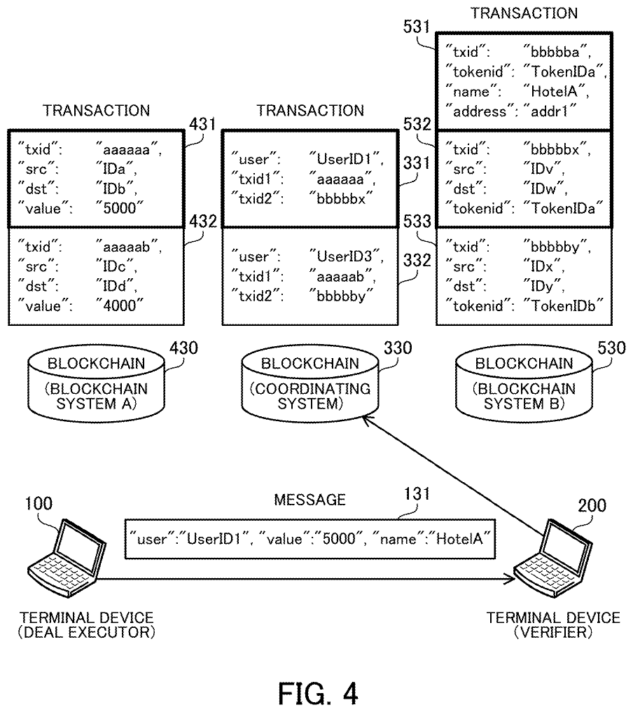

FIG. 4 illustrates a first example of deal proof using blockchains.

A blockchain 430 of the blockchain system 62 includes transactions 431 and 432. The transactions 431 and 432 are transactions representing remittances between users. The transactions 431 and 432 each include a transaction ID, a remittance source user ID, a remittance destination user ID, and an amount of money.

A blockchain 530 of the blockchain system 63 includes transactions 531, 532, and 533. The transaction 531 is a transaction representing a hotel use right. The transaction 531 includes a transaction ID, a token ID, and name and address of a hotel. The transactions 532 and 533 are transactions representing transfer of tokens between users. The transactions 532 and 533 each include a transaction ID, an assignor ID, an assignee ID, and a token ID. Note that the token ID included in the transaction 532 is the same as the token ID of the transaction 531.

A blockchain 330 of the coordinating system 61 includes transactions 331 and 332. The transaction 331 links the transactions 431 and 532. The transaction 332 links the transactions 432 and 533. The transactions 331 and 332 each include a user ID, the transaction ID of the blockchain system 62, and the transaction ID of the blockchain system 63.

The coordinating system 61 and the blockchain systems 62 and 63 individually assign a unique user ID to each user. Therefore, the user ID of the transaction 331, the remittance source user ID of the transaction 431, and the assignee ID of the transaction 532 are identifiers assigned to the same deal executor, but have different values. The transaction ID of the transaction 431 may be assigned by the blockchain system 62 or specified by the coordinating system 61. The transaction ID of the transaction 532 may be assigned by the blockchain system 63 or specified by the coordinating system 61.

The terminal device 100 transmits a message 131 to the terminal device 200. The message 131 includes a pair of an item name and an item value for each of the user ID, the amount of money, and the hotel name. The user ID included in the message 131 is the user ID of the transaction 331. The amount of money included in the message 131 is the amount of money of the transaction 431. The hotel name included in the message 131 is the hotel name of the transaction 531.

In this case, the terminal device 200 reads out the transaction 331 from the blockchain 330 based on the user ID included in the message 131. The terminal device 200 reads out the transaction 431 from the blockchain 430 based on the transaction ID included in the transaction 331. The terminal device 200 also reads out the transaction 532 from the blockchain 530, and reads out the transaction 531 based on the token ID included in the transaction 532.

Then, the terminal device 200 checks if the amount of money included in the message 131 is the same as the amount of money of the transaction 431, and if the hotel name included in the message 131 is the same as the hotel name of the transaction 531. Herewith, the terminal device 200 determines that each item value of the message 131 has not been tampered with and is genuine.

However, in the course of reading out the transaction 431 from the blockchain 430, the terminal device 200 learns of the user ID of the deal executor in the blockchain system 62. Therefore, transactions of other deals made by the deal executor may be read out from the blockchain 430. Similarly, in the course of reading out the transaction 532 from the blockchain 530, the terminal device 200 learns of the user ID of the deal executor in the blockchain system 63. Therefore, transactions of other deals made by the deal executor may be read out from the blockchain 530. Thus, there is a risk that the transmission of the message 131 could result in leaking to the verifier personal information of the deal executor, which is not subject to the verification.

One solution to the aforementioned problem is to record in the coordinating system 61 not the transaction IDs themselves of the blockchain systems 62 and 63 but hash values of the transaction IDs. In this case, the terminal device 100 transmits to the terminal device 200 the transaction IDs of blockchain systems in which the item values to be verified (hereinafter sometimes referred to as the “verification target item values”) are recorded. This prevents the terminal device 200 from reading out transactions of the blockchain systems, which do not have the verification target item values, and thus limits the range of item values disclosed to the verifier amongst item values related to a series of deals.

Note however that item values protected by the above method are on a blockchain system basis. If an item value recorded in a given blockchain system is a subject to verification, other item values of the same blockchain system, such as user IDs of the blockchain system, are not protected. Therefore, according to the second embodiment, the format of transactions of the coordinating system 61 and the format of messages transmitted from the terminal device 100 to the terminal device 200 are changed as below.

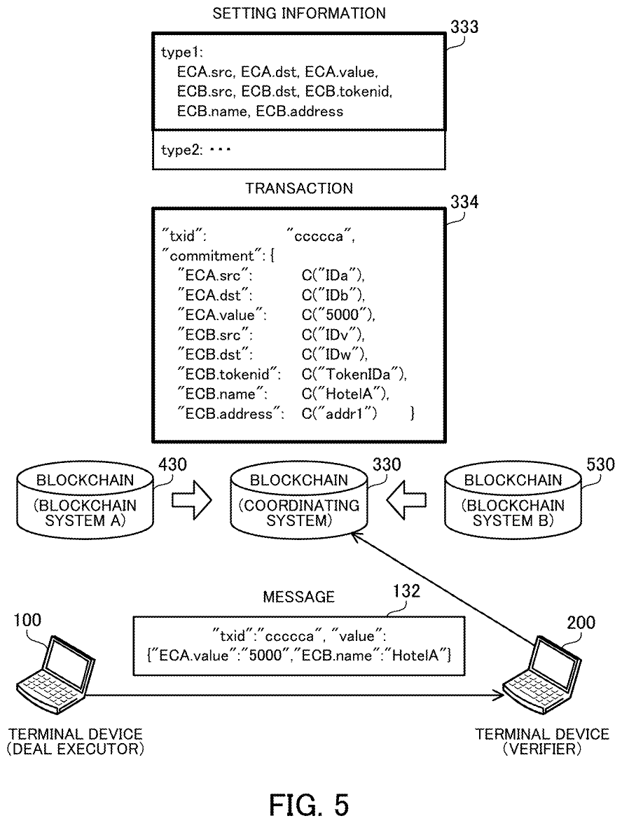

FIG. 5 illustrates a second example of deal proof using blockchains.

The coordinating system 61 stores setting information for each deal type. The setting information is created in advance by an administrator of the coordinating system 61. The setting information defines, amongst items included in transactions recorded in the blockchain systems 62 and 63, items included in transactions to be recorded in the coordinating system 61.

The items defined in the setting information may be all the items included in the transactions of the blockchain systems 62 and 63. Therefore, the items defined in the setting information may include the transaction IDs of the blockchain systems 62 and 63, and may include the user IDs of the deal executor, used in the blockchain systems 62 and 63. Alternatively, the items defined in the setting information may be limited to some items in light of deal proof aspects and confidential information protection. Hence, the items defined in the setting information do not need to include the transaction IDs of the blockchain systems 62 and 63, or to include the user IDs of the deal executor used in the blockchain systems 62 and 63.

Setting information 333 depicted in FIG. 5 is an example of the setting information. The setting information 333 defines the following items associated with the blockchain system 62: a remittance source user ID; a remittance destination user ID; and an amount of money. The setting information 333 also defines the following items associated with the blockchain system 63: an assignor ID; an assignee ID; a token ID; a hotel name; and a hotel address.

Upon reception of the transaction 431 of the blockchain system 62 and the transaction 532 of the blockchain system 63, a transaction 334 is recorded in the coordinating system 61. The transaction 334 includes a transaction ID given by the coordinating system 61. The transaction 334 also includes, for each of the multiple items defined in the setting information 333, a pair of an item name and a commitment.

Each commitment is confidential information converted from an original item value such that the original item value is difficult to guess. According to the second embodiment, each commitment is a hash value of the original item value. For the conversion from the item value into a hash value, a hash function, such as Secure Hash Algorithm (SHA)-256 is used. Note that a random number selected by the coordinating system 61 may be used to generate the commitment, as described below.

The transaction 334 includes commitments of the item values of the following items included in the transaction 431: the remittance source user ID; the remittance destination user ID; and the amount of money. The transaction 334 also includes commitments of the item values of the following items included in the transaction 532: the assignor ID; the assignee ID; and the token ID. The transaction 334 further includes commitments of the item values of the following items included in the transaction 531: the hotel name; and the hotel address. Thus, the commitments of various item values associated with a series of deals are collected in the transaction 334.

The terminal device 100 transmits a message 132 to the terminal device 200. The message 132 includes the transaction ID of the transaction 334 and, amongst the items included in the transaction 334, pairs of an item name and an item value of some items to be verified. In the example of FIG. 5, the verification target items are the payment amount and the hotel name. Note that a message transmitted from the terminal device 100 to the terminal device 200 may include a random number, as described later. In that case, the message includes information for proving that the terminal device 100 knows the correct random number.

The terminal device 200 receives the message 132 from the terminal device 100. In response, the terminal device 200 reads out the transaction 334 corresponding to the specified transaction ID from the blockchain 330 of the coordinating system 61. In addition, the terminal device 200 converts each item value included in the message 132 to a commitment.

The terminal device 200 compares, for each item, the commitment generated from the message 132 and the commitment included in the transaction 334. In this example, the terminal device 200 checks if the commitment of the payment amount matches the corresponding commitment included in the transaction 334, and if the commitment of the hotel name matches the corresponding commitment included in the transaction 334. Herewith, the terminal device 200 determines that each item value included in the message 132 has not been tampered with and is genuine.

At this time, the terminal device 200 need not access the blockchain systems 62 and 63. The terminal device 200 does not acquire the transaction ID of the transaction 431 and does not read out the transaction 431 from the blockchain system 62. In this manner, other item values of the transaction 431, such as the user IDs in the blockchain system 62, are protected. Similarly, the terminal device 200 does not acquire the transaction ID of the transaction 532, and does not read out the transaction 532 from the blockchain system 63. In this manner, other item values of the transaction 532, such as the user IDs in the blockchain system 63, are protected.

Note that even if the transaction IDs and user IDs of the blockchain systems 62 and 63 are items stored in the coordinating system 61, the item values of the transaction IDs and user IDs are concealed. This prevents the terminal device 200 from obtaining the item values of the transaction IDs and user IDs, which are not subject to verification, even if the terminal device 200 reads out the entire transaction 334.

Next described are functions and processing procedures of an information processing system.

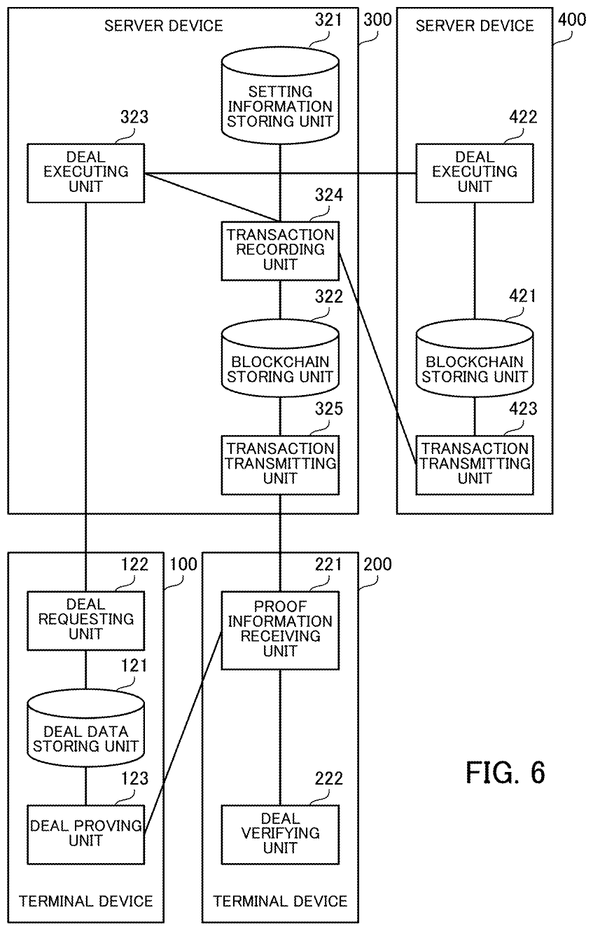

FIG. 6 is a block diagram illustrating an example of functions of the information processing system.

The terminal device 100 includes a deal data storing unit 121, a deal requesting unit 122, and a deal proving unit 123. The deal data storing unit 121 is implemented using, for example, the RAM 102 or the HDD 103. The deal requesting unit 122 and the deal proving unit 123 are implemented using, for example, the CPU 101, the communication interface 107, and programs.

The deal data storing unit 121 stores deal data received from the server device 300. The deal data includes a transaction ID for identifying an executed deal. The transaction ID is given by the coordinating system 61. The deal data also includes an item value of each of multiple items related to the deal. The item values included in the deal data have yet to be converted to commitments. The deal data stored in the deal data storing unit 121 may include a random number for each item, as described later.

The deal requesting unit 122 transmits a deal request to the server device 300 in accordance with an instruction from the deal executor. The deal request includes input data indicating a deal type and deal details. The deal requesting unit 122 receives deal data from the server device 300 as a response to the deal request. The deal requesting unit 122 stores the received deal data in the deal data storing unit 121.

The deal proving unit 123 generates, according to an instruction from the deal executor, proof information for proving the authenticity of item values included in the deal data and transmits the proof information to the terminal device 200. The deal proving unit 123 extracts, from the deal data stored in the deal data storing unit 121, the transaction ID and the item values of items selected by the deal executor, and inserts them into the proof information. The proof information may include random numbers of the items selected by the deal executor, as described later. Alternatively, instead of inserting the random numbers themselves into the proof information, the deal proving unit 123 may insert zero-knowledge proof information indicating that the terminal device 100 knows the random numbers.

The terminal device 200 includes a proof information receiving unit 221 and a deal verifying unit 222. The proof information receiving unit 221 and the deal verifying unit 222 are implemented using, for example, a CPU, a communication interface, and programs of the terminal device 200.

The proof information receiving unit 221 receives proof information from the terminal device 100. In response, the proof information receiving unit 221 accesses the server device 300 using the transaction ID included in the proof information, and receives a corresponding transaction from the server device 300. At this time, the proof information receiving unit 221 may read out the entire transaction from the server device 300, or may instead read out only the commitments of verification target items from the server device 300.

The deal verifying unit 222 verifies the authenticity of the item values received from the terminal device 100. The deal verifying unit 222 converts each of the item values received from the terminal device 100 into a commitment. The deal verifying unit 222 compares, for each item, the generated commitment with the commitment included in the transaction. The verification is successful if both match while the verification is failure if they do not match. The deal verifying unit 222 may generate a commitment from an item value and a random number, as described below. Instead of converting the item values into commitments, the deal verifying unit 222 may verify the authenticity of the item values based on the item values, the commitments included in the transaction, and the zero-knowledge proof information.

The server device 300 includes a setting information storing unit 321, a blockchain storing unit 322, a deal executing unit 323, a transaction recording unit 324, and a transaction transmitting unit 325. The setting information storing unit 321 and the blockchain storing unit 322 are implemented using, for example, a RAM or an HDD of the server device 300. The deal executing unit 323, the transaction recording unit 324, and the transaction transmitting unit 325 are implemented using, for example, a CPU, a communication interface, and programs of the server device 300.

The setting information storing unit 321 stores therein setting information for each deal type. The setting information defines items to be included in transactions recorded in the server device 300. The items defined in the setting information are all or part of items included in transactions recorded in the server devices 400 and 500. The setting information storing unit 321 also includes information on how to acquire item values of the items defined in the setting information from the server devices 400 and 500. Some item values may be difficult to obtain by acquiring a transaction only once by specifying a transaction ID, and may be obtained by acquiring another transaction using an item value included in the first acquired transaction.

The blockchain storing unit 322 stores therein the blockchain of the coordinating system 61. Each transaction included in this blockchain contains a transaction ID given by the coordinating system 61 and a pair of an item name and a commitment for each of multiple items defined in the setting information. Each commitment may be generated using a random number in addition to a corresponding item value, as described below.

The deal executing unit 323 receives a deal request from the terminal device 100. According to a deal type included in the received deal request, the deal executing unit 323 generates a deal request for blockchain systems, and transmits the generated deal request to the server devices 400 and 500. The deal request transmitted to the server devices 400 and 500 may include all or part of the input data included in the deal request received from the terminal device 100.

The deal executing unit 323 notifies the transaction recording unit 324 of transaction IDs of transactions recorded in the server devices 400 and 500. Transaction IDs for blockchain systems may be determined by the deal executing unit 323 and then designated to the server devices 400 and 500. On the other hand, the transaction IDs for blockchain systems may be determined by the server devices 400 and 500 and then reported to the deal executing unit 323. The deal executing unit 323 acquires deal data from the transaction recording unit 324 and transmits the acquired deal data to the terminal device 100 as a response to a deal request.

The transaction recording unit 324 records a transaction on the blockchain of the blockchain storing unit 322. The transaction recording unit 324 acquires transaction IDs of the blockchain systems 62 and 63 from the deal executing unit 323, and reads out setting information corresponding to the deal type from the setting information storing unit 321. The transaction recording unit 324 acquires transactions of the server devices 400 and 500 using the transaction IDs, and extracts the item values of items defined by the setting information from the transactions.

The transaction recording unit 324 generates a transaction ID of the coordinating system 61, and generates deal data including the generated transaction ID and a pair of an item name and an item value for each of multiple items defined in the setting information. The transaction recording unit 324 may select a random number for each item and include the random numbers in the deal data, as described below. The transaction recording unit 324 outputs the deal data to the deal executing unit 323. The transaction recording unit 324 also converts each of the item values of the deal data into a commitment and generates a transaction of the coordinating system 61. The transaction recording unit 324 records the generated transaction on the blockchain.

The transaction transmitting unit 325 reads out a transaction from the blockchain of the blockchain storing unit 322 in response to a request from the terminal device 200. The transaction transmitting unit 325 transmits to the terminal device 200 the entire read transaction or the commitments of items specified by the terminal device 200.

The server device 400 includes a blockchain storing unit 421, a deal executing unit 422, and a transaction transmitting unit 423. The blockchain storing unit 421 is implemented using, for example, a RAM or an HDD of the server device 400. The deal executing unit 422 and the transaction transmitting unit 423 are implemented using, for example, a CPU, a communication interface, and programs of the server device 400. The server device 500 may have modules similar to those of the server device 400. The blockchain storing unit 421 stores therein the blockchain of the blockchain system 62. Transactions included in this blockchain represent deals executed by the server device 400 in response to deal requests from the server device 300.

The deal executing unit 422 receives a deal request from the server device 300. The deal executing unit 422 executes a deal using input data included in the received deal request, and generates a transaction representing the deal results in the blockchain system 62. For example, the deal executing unit 422 generates a transaction for transferring a specified amount of money between specified users. The deal executing unit 422 records the transaction on the blockchain.

The transaction transmitting unit 423 reads out a transaction from the blockchain of the blockchain storing unit 421 in response to a request from the server device 300. The transaction transmitting unit 423 transmits the read transaction to the server device 300.

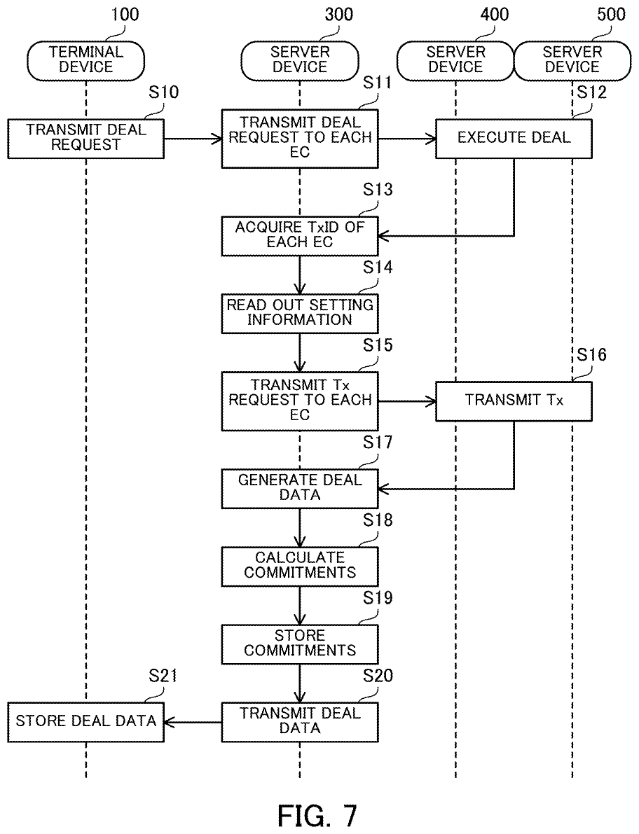

FIG. 7 is a flowchart illustrating an example of a deal execution procedure.

(Step S10) The deal requesting unit 122 generates a deal request including a deal type and input data in response to an input from the deal executor, and transmits the deal request to the server device 300.

(Step S11) The deal executing unit 323 receives the deal request from the terminal device 100. According to the deal type and input data indicated by the received deal request, the deal executing unit 323 identifies a deal to be requested to each of the blockchain systems 62 and 63. The deal executing unit 323 generates a deal request addressed to the blockchain system 62 and transmits it to the server device 400. The deal executing unit 323 also generates a deal request addressed to the blockchain system 63 and transmits it to the server device 500.

(Step S12) The deal executing unit 422 receives the deal request from the server device 300. The deal executing unit 422 generates a transaction based on the input data included in the received deal request and assigns a transaction ID to the transaction. The deal executing unit 422 writes the generated transaction to the blockchain of the blockchain system 62. The server device 500 also performs processing similar to that of the server device 400.

(Step S13) The deal executing unit 422 acquires transaction IDs of the individual blockchain systems 62 and 63. Note that transaction IDs for blockchain systems may be determined by the coordinating system 61. In that case, the deal executing unit 323 designates the transaction IDs to the server devices 400 and 500. Alternatively, transaction IDs for blockchain systems may be determined by individual blockchain systems. In that case, the deal executing unit 323 receives the transaction IDs from the server devices 400 and 500.

(Step S14) The transaction recording unit 324 reads out from the setting information storing unit 321 setting information corresponding to the deal type indicated by the deal request from the terminal device 100.

(Step S15) The transaction recording unit 324 generates a transaction request for reading out transactions of the blockchain systems 62 and 63 by using the transaction IDs acquired in step S13, and transmits the transaction request to each of the server devices 400 and 500.

(Step S16) The transaction transmitting unit 423 receives the transaction request from the server device 300. The transaction transmitting unit 423 reads out a transaction having the specified transaction ID from the blockchain and transmits it to the server device 300. The server device 500 also performs processing similar to that of the server device 400.

Note here that the transaction recording unit 324 may fail to collect the item values of all the items defined in the setting information with only one transaction request specifying the transaction ID. In that case, the transaction recording unit 324 may transmit an additional transaction request to the server devices 400 and 500 by using item values (e.g., token IDs) included in the acquired transactions. Information indicating how to collect such item values may be stored in the setting information storing unit 321.

(Step S17) The transaction recording unit 324 determines a transaction ID for the coordinating system 61. The transaction recording unit 324 also extracts item values of the items defined in the setting information from the transactions collected from the server devices 400 and 500. Then, the transaction recording unit 324 generates deal data. The deal data includes the transaction ID of the coordinating system 61. The deal data also includes a pair of an item name and an item value for each of the multiple items.

(Step S18) The transaction recording unit 324 calculates, for each of the multiple items included in the deal data, a commitment from the item value. For example, the transaction recording unit 324 calculates a hash value by inputting the item value to a hash function.

Note however that the transaction recording unit 324 may generate a commitment from the item value and a random number, as described below. In that case, the transaction recording unit 324 selects a random number for each item. For example, the transaction recording unit 324 connects the random number to the end of the item value, which is then input to the hash function. Alternatively, the transaction recording unit 324 calculates, for example, the product of the item value and the random number, and inputs the product to the hash function.

(Step S19) The transaction recording unit 324 generates a transaction. The transaction corresponds to the deal data in which the item values are replaced with the commitments. Therefore, the transaction includes the transaction ID of the coordinating system 61. The transaction also includes, for each of the multiple items, a pair of an item name and a commitment. The transaction recording unit 324 writes the transaction on the blockchain.

(Step S20) The deal executing unit 323 transmits the deal data generated in step S17 to the terminal device 100. Note however that, when random numbers are used to generate the commitments, the deal data transmitted to the terminal device 100 further includes multiple random numbers corresponding to the multiple items.

(Step S21) The deal requesting unit 122 receives the deal data from the server device 300. The deal requesting unit 122 stores the received deal data in the deal data storing unit 121.

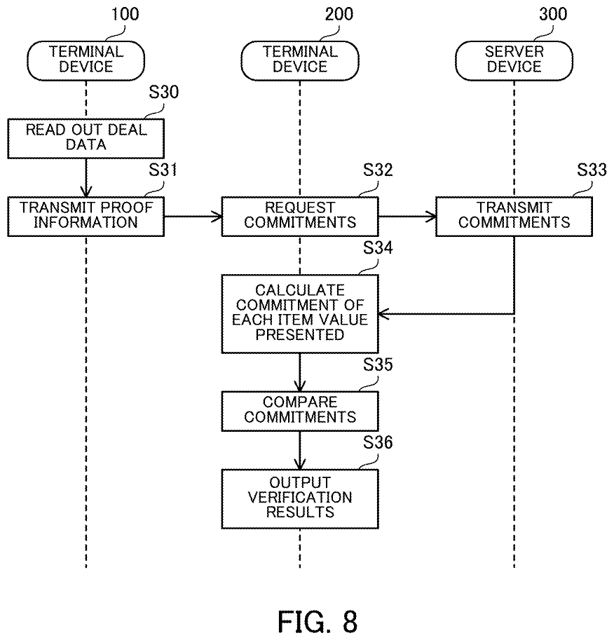

FIG. 8 is a flowchart illustrating an example of a deal proof procedure.

(Step S30) The deal proving unit 123 receives from the deal executor a specification of items for which authenticity is desired to be proven. The deal proving unit 123 reads out the deal data from the deal data storing unit 121.

(Step S31) The deal proving unit 123 extracts some information from the deal data and generates proof information. The proof information includes a transaction ID and pairs of an item name and an item value for the items specified by the deal executor. The proof information may include random numbers of the items specified by the deal executor, as described below. In place of the random numbers of the specified items, the proof information may include zero-knowledge proof information. The zero-knowledge proof information is information proving that the terminal device 100 knows random numbers satisfying the condition that each commitment generated from an item value and a random number matches the corresponding one recorded in the coordinating system 61. The deal proving unit 123 transmits the generated proof information to the terminal device 200.

(Step S32) The proof information receiving unit 221 receives the proof information from the terminal device 100. The proof information receiving unit 221 transmits a commitment request to the server device 300, with a designation of the transaction ID included in the proof information. At this time, the proof information receiving unit 221 may acquire the entire transaction corresponding to the specified transaction ID, or may acquire only the commitment associated with each item name included in the proof information.

(Step S33) The transaction transmitting unit 325 reads out a transaction having the transaction ID specified by the terminal device 100 from the blockchain of the coordinating system 61. The transaction transmitting unit 325 transmits the entire transaction, or part of it, i.e., the corresponding commitments, to the terminal device 200.

(Step S34) The deal verifying unit 222 calculates a commitment from each item value included in the proof information received from the terminal device 100. For example, the deal verifying unit 222 calculates a hash value by inputting the item value to a hash function. The hash function used is agreed between the terminal device 200 and the server device 300 in advance.

However, the deal verifying unit 222 may generate each commitment from an item value and a random number, as described below. For example, the deal verifying unit 222 connects the random number included in the proof information to the end of the item value, which is then input to the hash function. Alternatively, the deal verifying unit 222 calculates, for example, the product of the item value and the random number, and inputs the product to the hash function.

(Step S35) The deal verifying unit 222 compares, for each item, the commitment calculated in step S34 with the commitment received from the server device 300. The deal verifying unit 222 determines that the verification is successful if the two commitments match, and determines that the verification is failure if the two commitments do not match.

Note however that there may be a case where, although the commitments of the coordinating system 61 depend on random numbers, the random numbers themselves are not presented by the terminal device 100, as described later. In that case, the deal verifying unit 222 inputs, into a specific verification function, each item value presented by the terminal device 100, the corresponding commitment recorded in the coordinating system 61, and the zero-knowledge proof information received from the terminal device 100. If the verification of the zero-knowledge proof information is successful, the deal verifying unit 222 finds that the terminal device 100 knows the correct random numbers and determines that the verification of the item values is successful. On the other hand, if the verification of the zero-knowledge proof information fails, the deal verifying unit 222 finds that the terminal device 100 does not know the correct random numbers and determines that the verification of the item values has failed.

(Step S36) The deal verifying unit 222 outputs verification results indicating if the presented item values have been verified successfully. For example, the deal verifying unit 222 displays the verification results on a display device of the terminal device 200; transmits them to the terminal device 100 or a different information processing apparatus; and/or stores them in a non-volatile storage device.

Next described is a case of using random numbers to generate commitments.

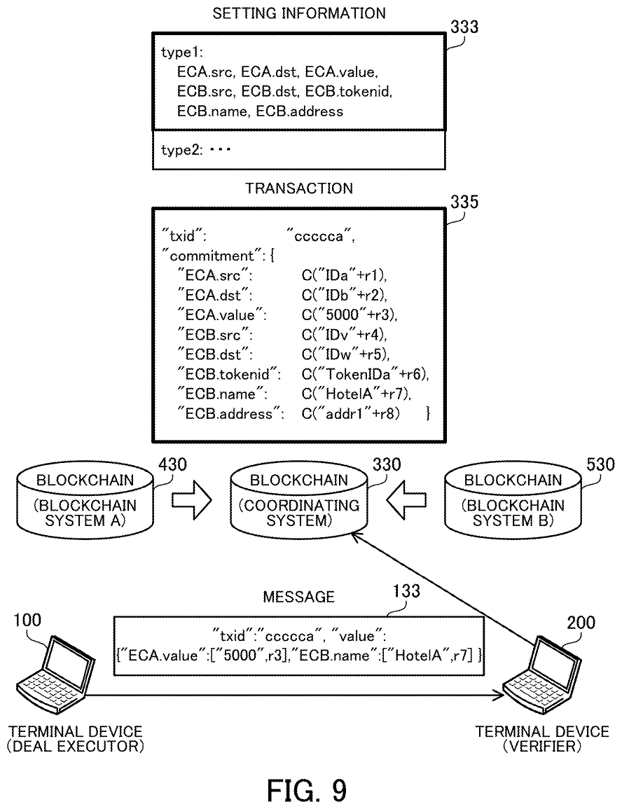

FIG. 9 illustrates a third example of deal proof using blockchains.

A transaction 335 is recorded on the blockchain 330 of the coordinating system 61. The transaction 335 includes a transaction ID given by the coordinating system 61. The transaction 335 also includes, for each of the multiple items defined in the setting information 333, a pair of an item name and a commitment.

Each commitment is a hash value calculated from an original item value and a random number. For example, the server device 300 connects a random number to the end of the original item value, which is then input to a hash function. Alternatively, the server device 300 inputs, for example, the product of the original item value and the random number to the hash function. The server device 300 preferably selects a different random number for each item. After deal execution, the server device 300 notifies the terminal device 100 of the random numbers in addition to the item values.

The terminal device 100 transmits a message 133 to the terminal device 200. The message 133 includes the transaction ID of the transaction 335, and the item names, item values, and random numbers of some items to be verified amongst the items included in the transaction 335.

The terminal device 200 receives the message 133 from the terminal device 100. Then, the terminal device 200 reads out the transaction 335 corresponding to the transaction ID from the blockchain 330 of the coordinating system 61. The terminal device 200 also calculates individual commitments from the item values and the random numbers included in the message 133. The terminal device 200 compares, for each item, the commitment generated from the message 133 with the commitment included in the transaction 335.

Some items may have few item value candidates. When random numbers are not used, the terminal device 200 may be able to guess an item value not disclosed by the terminal device 100 through calculating commitments of the item value candidates in a round-robin manner and then comparing them with the corresponding commitment of the transaction 335. On the other hand, when random numbers are used, it is difficult for the terminal device 200 to guess an item value not disclosed by the terminal device 100 in a round-robin manner.

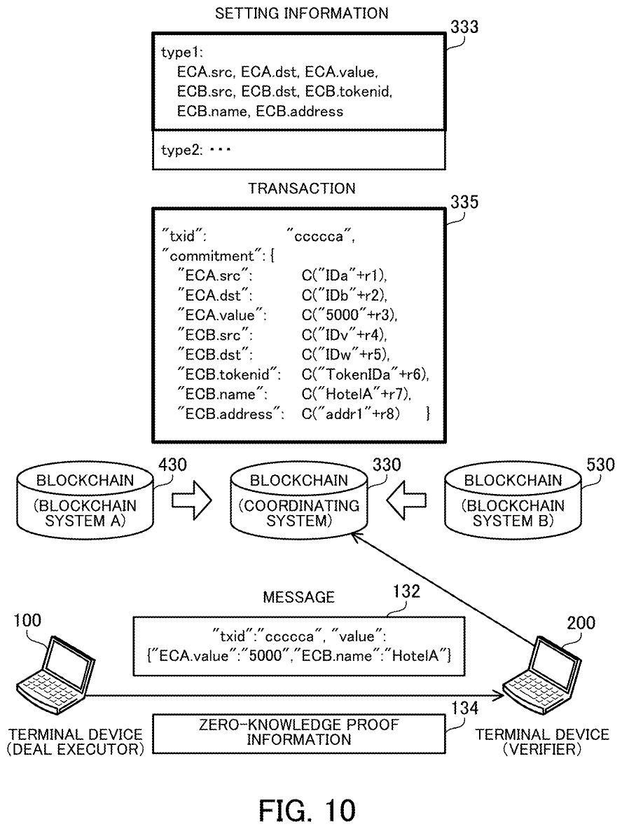

FIG. 10 illustrates a fourth example of deal proof using blockchains.

The above transaction 335 is recorded on the blockchain 330 of the coordinating system 61. Therefore, random numbers are used to generate the commitments of the coordinating system 61. On the other hand, the terminal device 100 transmits to the terminal device 200 the message 132 including no random numbers. In addition to the message 132, the terminal device 100 also transmits zero-knowledge proof information 134 to the terminal device 200.

Zero-knowledge proof is described, for example, in the following non-patent literature: Bryan Parno, Jon Howell, Craig Gentry and Mariana Raykova, “Pinocchio: Nearly Practical Verifiable Computation”, Proc. of the 2013 IEEE Symposium on Security and Privacy, May 19, 2013.

The zero-knowledge proof information 134 is information for proving that the terminal device 100 knows a random number r3 corresponding to the amount of money and a random number r7 corresponding to the hotel name, without disclosing the random numbers r3 and r7 themselves. The zero-knowledge proof information 134 includes a set of numerical values generated by a particular algorithm. For example, the terminal device 100 generates the zero-knowledge proof information 134 from the item values and random numbers of the items to be verified and parameters according to a hash function used. The zero-knowledge proof information 134 may be generated separately for each item.

The terminal device 200 does not convert the item values included in the message 132 into commitments because random numbers are not disclosed by the terminal device 100. Instead, based on the item values included in the message 132, the commitments included in the transaction 335, and the zero-knowledge proof information 134, the terminal device 200 verifies the claim of the terminal device 100 that the terminal device 100 knows the correct random numbers. The zero-knowledge proof utilizes the property that the probability of a person not knowing the correct random numbers being able to accidentally generate the zero-knowledge proof information 134 that matches the item values and the commitments is sufficiently small. The terminal device 100 uses a specific algorithm to generate a set of numerical values satisfying such a property as the zero-knowledge proof information 134.

If the terminal device 100 transmits the random numbers to the terminal device 200, the verifier learns the true item values and random numbers for the verification target items. In this case, for the deal, the verifier may be able to impersonate the deal executor to yet another verifier. On the other hand, by transmitting zero-knowledge proof information to the terminal device 200 instead of the random numbers, the terminal device 100 prevents impersonation using the random numbers.

As described above, in the information processing system of the second embodiment, the blockchain systems 62 and 63 cooperate via the coordinating system 61 to execute a series of information processing. This allows flexible execution of various deals. In addition, transactions representing execution results of the deals are recorded on the blockchains. This improves the reliability of the transactions. Further, transactions distributed and recorded in the blockchain systems 62 and 63 are mapped to one another by the coordinating system 61. This facilitates deal verifications.

In addition, the terminal device 200 verifies item values received from the terminal device 100 by referring to a transaction recorded in the coordinating system 61. Herewith, the terminal device 100 is able to prove the authenticity of the item values to the terminal device 200.

In addition, the coordinating system 61 collects item values corresponding to a deal type from the blockchain systems 62 and 63 and records, for each item, a commitment of the item value on the blockchain. Herewith, the terminal device 100 is able to limit item values to be transmitted to the terminal device 200 amongst multiple item values included in the deal data to the verification target item values. Further, this prevents the terminal device 200 from acquiring item values not subject to verification from the coordinating system 61, which in turn reduces the risk of confidential information of the deal executor being leaked to the verifier.

In addition, even if the terminal device 200 refers to a transaction of the coordinating system 61, it is difficult to identify transactions of the blockchain systems 62 and 63 from which information is collected. Therefore, the risk of confidential information leaking from the blockchain systems 62 and 63 is also suppressed. Further, compared to the case where the terminal device 100 transmits transaction IDs of specific blockchain systems to the terminal device 200, item values are protected with finer granularity than a blockchain system basis.

In addition, the use of random numbers to generate commitments reduces the risk of original item values being guessed by round-robin from the commitments recorded in the coordinating system 61. In addition, transmission of zero-knowledge proof information, in place of the random numbers, from the terminal device 100 to the terminal device 200 reduces the risk of impersonation by the verifier.

The foregoing is merely illustrative of the principles of the present invention. Further, numerous modifications and changes will readily occur to those skilled in the art, and therefore, it is not desired to limit the disclosed technology to the exact construction and applications illustrated and described above. Accordingly, all suitable modifications and equivalents may be resorted to, falling within the scope of the present invention determined by appended claims and their equivalents.

According to an aspect, it is possible to limit deal information to be disclosed to a verifier.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A verification method comprising:
receiving, by a processor, a first identification information piece for identifying a first deal performed by a user and a first item information piece specified by the user amongst a plurality of first item information pieces included in execution results of the first deal;
acquiring, by the processor, in reference to a memory for storing, for each of a plurality of deals, an identification information piece for identifying the deal in association with a plurality of confidential information pieces which is individually generated by concealing each of a plurality of item information pieces included in execution results of the deal, at least a first confidential information piece corresponding to the specified first item information piece amongst a plurality of first confidential information pieces associated with the first identification information piece; and
verifying, by the processor, authenticity of the specified first item information piece based on a correspondence between the specified first item information piece and the acquired first confidential information piece.

2. The verification method according to claim 1, wherein the plurality of item information pieces is recorded on a first blockchain, and the identification information piece and the plurality of confidential information pieces are recorded on a second blockchain.

3. The verification method according to claim 1, wherein the plurality of confidential information pieces is hash values calculated from the plurality of item information pieces.

4. The verification method according to claim 1, wherein:
the plurality of confidential information pieces is generated from the plurality of item information pieces and random numbers,
the receiving includes receiving a first random number in addition to the first identification information piece and the first item information piece, and
the verifying includes verifying the authenticity based on a correspondence among the specified first item information piece, the received first random number, and the acquired first confidential information piece.

5. The verification method according to claim 1, wherein:
the plurality of confidential information pieces is generated from the plurality of item information pieces and random numbers,
the receiving includes receiving zero-knowledge proof information for proving that the user knows a first random number, in addition to the first identification information piece and the first item information piece, and
the verifying includes verifying the authenticity based on a correspondence among the specified first item information piece, the acquired first confidential information piece, and the zero-knowledge proof information.

6. An information processing apparatus comprising:
a communication interface configured to receive a first identification information piece for identifying a first deal performed by a user and a first item information piece specified by the user amongst a plurality of first item information pieces included in execution results of the first deal; and
a processor configured to execute a process including:
acquiring, in reference to a memory for storing, for each of a plurality of deals, an identification information piece for identifying the deal in association with a plurality of confidential information pieces which is individually generated by concealing each of a plurality of item information pieces included in execution results of the deal, at least a first confidential information piece corresponding to the specified first item information piece amongst a plurality of first confidential information pieces associated with the first identification information piece, and
verifying authenticity of the specified first item information piece based on a correspondence between the specified first item information piece and the acquired first confidential information piece.

7. A non-transitory computer-readable recording medium storing therein a computer program that causes a computer to execute a process comprising:
receiving a first identification information piece for identifying a first deal performed by a user and a first item information piece specified by the user amongst a plurality of first item information pieces included in execution results of the first deal;
acquiring, in reference to a memory for storing, for each of a plurality of deals, an identification information piece for identifying the deal in association with a plurality of confidential information pieces which is individually generated by concealing each of a plurality of item information pieces included in execution results of the deal, at least a first confidential information piece corresponding to the specified first item information piece amongst a plurality of first confidential information pieces associated with the first identification information piece; and
verifying authenticity of the specified first item information piece based on a correspondence between the specified first item information piece and the acquired first confidential information piece.
